(19) United States
(12) Patent Application Publication
(10) Pub. No.: US 2026/0059399 A1
(43) Pub. Date: Feb. 26, 2026

(54) CONDITIONAL HANDOVER

(71) Applicant: Nokia Technologies Oy, Espoo (FI)

(72) Inventors: Umur KARABULUT, Munich (DE); Krzysztof KORDYBACH, Wroclaw (PL); Halit Murat GÜRSU, Munich (DE); Amaanat ALI, Espoo (FI); Panagiotis SPAPIS, Munich (DE); Ahmad AWADA, Munich (DE)

(21) Appl. No.: 19/104,193

(22) PCT Filed: Jul. 11, 2023
(86) PCT No.: PCT/EP2023/069228

§ 371 Date: Feb. 14, 2025

(30) Foreign Application Priority Data
Aug. 16, 2022 (GB) 2211939.0

(51) Int. Cl. H04W 36/00; H04W 36/36

(52) U.S. Cl. CPC H04W 36/0069; H04W 36/362

(57) ABSTRACT

In some examples, a method, performed in a target master node of a radio network, for preparing handover of user equipment, UE, in dual connectivity, DC, where the handover is between respective primary cells, PCells, of a source master node and a target master node, and respective primary secondary cells, PSCells, of a source secondary node and a target secondary node, comprises receiving, from the source master node, a conditional handover, CHO, request message comprising a unique identifier for the UE defined between the source master node and the target secondary node, and an identifier for the target secondary node, transmitting the unique identifier for the UE to the target secondary node as part of an secondary node addition request for CHO with DC preparation, receiving, from the target secondary node, an acknowledgement message to confirm CPC preparation for the UE, the acknowledgement message comprising a full secondary cell group, SCG, configuration.

### TECHNICAL FIELD

The present invention relates generally to fifth generation (5G) New Radio (NR) systems. Aspects relate to conditional handovers in 5G NR systems.

### BACKGROUND

The fifth generation (5G) New Radio (NR) system is designed to provide flexibility and configurability to optimize network services and types, accommodating various use cases. A new handover procedure provided as part of the 5G NR system enables user equipment (UE) to decide to perform handover when certain conditions are met. This NR handover procedure is called conditional handover (CHO) and executes in contrast to the legacy handover procedure in which the network was in charge of making the decision as to whether handover should be performed or not. It was thus a reactive process and prone to resulting handover failures.

CHO, on the other hand, is a handover that is executed by the UE when one or more handover execution conditions are met. Specifically, a UE can begin to evaluate the execution condition(s) upon receiving a CHO configuration, and may cease evaluation of the execution condition(s) once a handover is executed.

### SUMMARY

An objective of the present disclosure is to enable CHO-DC configuration validity for a target delta SCG configuration in the context of CHO-CPC coexistence, and avoidance of double resource reservation.

The foregoing and other objectives are achieved by the features of the independent claims.

Further implementation forms are apparent from the dependent claims, the description and the Figures.

A first aspect of the present disclosure provides a method, performed in a target master node of a radio network, for preparing handover of user equipment, UE, in dual connectivity, DC, where the handover is between respective primary cells, PCells, of a source master node and a target master node, and respective primary secondary cells, PSCells, of a source secondary node and a target secondary node, the method comprising receiving, from the source master node, a conditional handover, CHO, request message comprising a unique identifier for the UE defined between the source master node and the target secondary node, and an identifier for the target secondary node, transmitting the unique identifier for the UE to the target secondary node as part of an secondary node addition request for CHO with DC preparation, and receiving, from the target secondary node, an acknowledgement message to confirm CPC preparation for the UE, the acknowledgement message comprising a full secondary cell group, SCG, configuration.

A target master node and target secondary node are informed about ongoing CPC preparations. Accordingly, the target secondary will not reserve double resources for the same UE. Furthermore, a full SCG configuration is provided rather than a delta SCG configuration, thereby preventing SCG configuration validity issues in case of a change in serving secondary node.

In an implementation of the first aspect, a handover request acknowledgement message comprising data representing an indication that the CHO with DC contains a full SCG configuration as well as an indication that the provided configuration will be maintained by the UE after the execution of ongoing CPC configuration of the UE is transmitted to the source master node.

The method can further comprise receiving, from the source master node, a confirmation of UE handover from the source secondary node to the target secondary node. The method can further comprise receiving, from the target secondary node, a confirmation of UE handover from the source secondary node to the target secondary node.

In an example, the full SCG configuration can be valid before and after execution of UE handover from the source secondary node to the target secondary node.

A second aspect of the present disclosure provides a source master node in a radio network, the source master node comprising a processor, a memory coupled to the processor, the memory configured to store program code executable by the processor, the program code comprising one or more instructions, whereby to cause the source master node to transmit, to a target master node of the radio network, a CHO request message comprising a unique identifier for the UE defined between the source master node and the target secondary node, and an identifier for the target secondary node, and receive, from the target master node of the radio network, a handover request acknowledgement message comprising data representing an indication that the CHO configuration contains a full SCG configuration as well as an indication that the provided configuration will be maintained by the UE after the execution of ongoing CPC configuration of the UE.

In an implementation of the second aspect, the program code can further comprise one or more instructions, whereby to cause the source master node to transmit, to the target master node, a confirmation of UE handover. The program code can further comprise one or more instructions, whereby to cause the source master node to transmit, to the UE, data comprising an indication that the CHO with DC configuration is to be maintained after execution of the CPC.

A third aspect of the present disclosure provides a machine-readable storage medium encoded with instructions for preparing handover of user equipment, UE, in dual connectivity, DC, where the handover is between respective primary cells, PCells, of a source master node and a target master node, and respective primary secondary cells, PSCells, of a source secondary node and a target secondary node, the the instructions executable by a processor of the target master node, whereby to cause the target master node to receive, from the source master node, a conditional handover, CHO, request message comprising a unique identifier for the UE defined between the source master node and the target secondary node, and an identifier for the target secondary node, transmit the unique identifier for the UE to the target secondary node as part of an secondary node addition request for CHO with DC preparation, and receive, from the target secondary node, an acknowledgement message to confirm CPC preparation for the UE, the acknowledgement message comprising a full secondary cell group, SCG, configuration.

The machine-readable storage medium can be further encoded with instructions executable by the processor of the target master node, whereby to cause the target master node to transmit, to the source master node, a handover request acknowledgement message comprising data representing an indication that the CHO with DC contains a full SCG configuration as well as an indication that the provided configuration will be maintained by the UE after the execution of ongoing CPC configuration of the UE.

The machine-readable storage can be further encoded with instructions executable by the processor of the target master node, whereby to cause the target master node to receive, from the source master node, a confirmation of UE handover from the source secondary node to the target secondary node.

The machine-readable storage medium can be further encoded with instructions executable by the processor of the target master node, whereby to cause the target master node to receive, from the target secondary node, a confirmation of UE handover from the source secondary node to the target secondary node.

A fourth aspect of the present disclosure provides a target master node in a radio network, the target master node comprising a processor, a memory coupled to the processor, the memory configured to store program code executable by the processor, the program code comprising one or more instructions, whereby to cause the target master node to receive, from a source master node, a conditional handover, CHO, request message comprising a unique identifier for a UE defined between the source master node and a target secondary node, and an identifier for the target secondary node, transmit the unique identifier for the UE to the target secondary node as part of an secondary node addition request for CHO with DC preparation, and receive, from the target secondary node, an acknowledgement message to confirm CPC preparation for the UE, the acknowledgement message comprising a full secondary cell group, SCG, configuration.

The program code can further comprise one or more instructions, whereby to cause the target master node to transmit, to the source master node, a handover request acknowledgement message comprising data representing an indication that the CHO with DC contains a full SCG configuration as well as an indication that the provided configuration will be maintained by the UE after the execution of ongoing CPC configuration of the UE.

The program code can further comprise one or more instructions, whereby to cause the target master node to receive, from the source master node, a confirmation of UE handover from the source secondary node to the target secondary node.

### BRIEF DESCRIPTION OF THE FIGURES

Embodiments will now be described by way of example only with reference to the figures, in which:

FIG. 1 is a schematic representation of message flow according to an example;

FIG. 2 is a schematic representation of a machine according to an example; and

FIG. 3 is a flow chart of a method according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. The term “and/or” is only an association relationship for describing associated objects and represents that three relationships may exist such that A and/or B may indicate that A exists alone, A and B exist at the same time, or B exists alone. The character “/”generally represents that the associated objects are in an “or”relationship.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

The phrases “in one implementation,” or “in some implementations,” may each refer to one or more of the same or different implementations. The term “coupled” is defined as connected whether directly or indirectly through intervening components and is not necessarily limited to physical connections. The expression “at least one of A, B and C” or “at least one of the following: A, B and C” means “only A, or only B, or only C, or any combination of A, B and C.”

The terms “system”and “network”may be used interchangeably.

For the purposes of explanation and non-limitation, specific details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof

A software implementation may include machine-and/or computer-readable and/or executable instructions stored on a machine-and/or computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long Term Evolution (LTE) system, an LTE-Advanced (LTE-A) system, an LTE-Advanced Pro system, or a 5G NR Radio Access Network (RAN) typically includes at least one base station (BS), at least one user equipment (UE), and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

A BS can provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

A BS may include but is not limited to a node B (NB) in the UMTS, an evolved node B (eNB) in LTE or LTE-A, a radio network controller (RNC) in UMTS, a BS controller (BSC) in the GSM/GERAN, a next generation (ng)-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. A BS may serve one or more UEs via a radio interface.

A BS can provide radio coverage to a specific geographical area using a plurality of cells forming the RAN. The BS supports the operations of the cells. Each cell is operable to provide services to at least one UE within its radio coverage.

Each cell (often referred to as a serving cell) can provide services to serve one or more UEs within its radio coverage such that each cell schedules the downlink (DL) and optionally uplink (UL) resources to at least one UE within its radio coverage for DL and optionally UL packet transmissions. The BS can communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

A frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used.

### Examples of Some Terms Used in the Present Disclosure Are

Primary Cell (PCell): A PCell is the master cell group (MCG) cell, operating on the primary frequency, in which a UE either performs the initial connection establishment procedure or initiates the connection re-establishment procedure. A PCell is the special cell (SpCell) of the MCG.

Primary SCG Cell (PSCell): For dual connectivity (DC) operation, PSCell is the secondary cell group (SCG) cell in which the UE performs random access when performing the Reconfiguration with Sync procedure. PSCell is the SpCell of the SCG. In some implementations, the term PSCell may refer to a Primary Secondary Cell. The term “Primary SCG Cell” and the term “Primary Secondary Cell” may be used interchangeably in the present disclosure.

Special Cell (SpCell): For DC operation the term Special Cell (SpCell) refers to the PCell of the MCG or the PSCell of the SCG, otherwise the term Special Cell refers to the PCell.

Secondary Cell (SCell): For a UE configured with carrier aggregation (CA), SCell is a cell providing additional radio resources on top of Special Cell.

Serving Cell: For a UE in RRC_CONNECTED not configured with CA/DC there is only one serving cell comprising the primary cell. For a UE in RRC_CONNECTED configured with CA/DC the term “serving cells” is used to denote the set of cells comprising the Special Cell(s) and all secondary cells.

Master Cell Group (MCG): in MR-DC, MCG is a group of serving cells associated with the Master Node, comprising the SpCell (PCell) and optionally one or more SCells.

Master Node (MN): in MR-DC, a MN or primary node is the radio access node that provides the control plane connection to the core network. It may be a Master eNB (in EN-DC), a Master ng-eNB (in NGEN-DC) or a Master gNB (in NR-DC and NE-DC). In some implementations, a MN or primary node can comprise a source or target node for a UE.

Secondary Cell Group (SCG): in MR-DC, SCG is a group of serving cells associated with the Secondary Node, comprising of the SpCell (PSCell) and optionally one or more SCells.

Secondary Node (SN): in MR-DC, SN is the radio access node, with no control plane connection to the core network, providing additional resources to the UE. It may be an en-gNB (in EN-DC), a Secondary ng-eNB (in NE-DC) or a Secondary gNB (in NR-DC and NGEN-DC). In some implementations, a SN or secondary node can comprise a source or target node for a UE.

In a wireless communication network, such as E-UTRAN, one of the main causes of handover (HO) failure is a UE not receiving a Handover Command message from a source base station (e.g., a source eNB or a source gNB) or a serving base station (e.g., a serving eNB or a serving gNB). A conventional handover procedure is usually triggered by a measurement report from the UE. For example, when the serving cell's quality (e.g., signal strength and/or service quality) is below a preconfigured threshold and a neighbouring cell's quality (e.g., signal strength and/or service quality) is above a preconfigured threshold, the UE may send a measurement report to the source base station under the serving cell based on the received measurement configurations. Upon receiving the measurement report, the source base station may send a Handover Request message to multiple target base stations (e.g., eNB or gNB) for admission control, and receive Handover Acknowledgement messages from the target base stations. The source base station may select and send a Handover Command message (which may be included in a Handover Acknowledgement message from one of the target base stations) to the UE so that the UE can connect to the target cell.

The success of the overall handover procedure depends on several factors. One of the factors is that the serving cell quality does not drop rapidly within a short period of time, which may be dominated by the latency of the backhaul (e.g., for X2/Xn/Xx interface), the processing time of target base stations, and the signalling transmission time. However, in real-world situations, serving cell quality can drop quickly within a short period of time, and a UE may not successfully receive a Handover Command message before the serving cell quality drops significantly. As a result, the UE may detect a radio link failure. Consequently, in response to the detected radio link failure, the UE may initiate a radio resource control (RRC) Connection Re-establishment procedure, which in turn leads to a considerable amount of service interruption time.

In a next generation wireless network (e.g., a 5G NR network), with massive antenna beamforming in higher frequency bands, a serving cell quality may degrade even faster, especially when narrow beams are used to serve the UE. Blockage is another problem in NR deployments.

The 3GPP has introduced the concept of conditional handover (CHO) to improve reliability of the overall handover procedure. The CHO procedure may be viewed as a supplementary procedure to the conventional handover procedure to help reduce the handover failure rate.

To execute a conditional reconfiguration command, a UE may evaluate the triggering condition(s) associated with the conditional reconfiguration command to determine whether one or more triggering conditions (or executions conditions) for the conditional reconfiguration command is met. When the UE determines that a triggering condition is satisfied, the UE may apply the corresponding conditional reconfiguration command to connect to the target cell. Existing measurement events (e.g., A3 and A5) may be used for determining whether a triggering condition of a conditional reconfiguration command is satisfied.

CHO may help to improve reliability of the overall handover procedure. Applying concepts similar to CHO may also be beneficial to a PSCell addition procedure, a PSCell change procedure, an SN addition procedure, or an SN change procedure for MR-DC mode, because preparation between the MN and the SN and RRC signalling to add the SN may finish in advance.

A UE may behave differently when concepts of CHO (or conditional configuration) are applied to a normal HO (e.g., PCell change) procedure or a PSCell addition/change (or SN addition/change) procedure. For example, the UE may not need to release the link to the current PCell (or MN) if the executed conditional reconfiguration command is for PSCell addition/change. Some information or guideline (e.g., by implicit manner) for the UE to determine what to do when a conditional reconfiguration command is executed may be required. In addition, the principles for applying CHO (or conditional configuration) to PCell change and the principles for applying CHO (or conditional configuration) to PSCell addition/change may be different due to different purposes.

A conditional reconfiguration procedure may be a reconfiguration procedure executed by the UE when one or more execution conditions (also referred to as triggering conditions) are met. There are three types of conditional reconfiguration. The first type is conditional reconfiguration for PCell change, also referred to as conditional reconfiguration for handover or conditional handover (CHO). The second type is conditional reconfiguration for PSCell change, also referred to as conditional PSCell change (CPC). The third type is conditional reconfiguration for PSCell addition, also referred to as conditional PSCell addition (CPA).

CHO may be a handover procedure that is executed by the UE when one or more handover execution conditions are met. The UE may start evaluating the execution condition(s) upon receiving the CHO configuration and may stop evaluating the execution condition(s) once the execution condition(s) is met. In some implementations, an execution condition may include, for example, A3/A5 events. In some implementations, an execution condition may consist of one or two trigger condition(s).

In the context of a CHO-CPC co-existence framework, there will are two configurations that are provided to a UE and that running in parallel. That is, the UE in question monitors both of the measurements for both configurations. One configuration is a CHO configuration with a CHO execution condition (either with or without DC connection, i.e., including SN connection), and the other configuration is a conditional PSCell change (CPC) configuration and CPC execution condition provided to the UE and which also run in parallel.

In the event that the UE is connected to a PCell under MN and a PSCell under SN (i.e., in a DC setup), it is possible that the UE hands over to a target cell in another MN and that this target cell requests to maintain the serving PSCell of the UE.

However, if initially the source MN prepares the CPC of a UE from a source SN to a target SN, the source MN initiates CHO preparation of the target MN where the target MN provides the CHO-DC configuration, i.e., it prepares the target SN (that the source MN also prepared for CPC) with a delta (i.e., partial) configuration for a CHO preparation. In such a case, a CHO-CPC coexistence validity problem occurs since the CHO-DC configuration gets invalidated if the CPC is executed first, i.e., CPC execution leads to a serving SN change and the SN delta configuration of the CHO-DC configuration cannot be applied on new serving SN. To avoid the SN failure, the CHO-DC preparation is re-initiated at the cost of extra signalling overhead and delayed CHO-DC configuration given to the UE.

Furthermore, both serving and target MNs prepare the same target SN for the UE switch. Accordingly, the source MN prepares CPC towards the target SN first, and the target MN prepares the same target SN for CHO-DC handover. In that case, the target SN is not aware that the same UE will be prepared during CHO-DC of the target MN, and so the target SN will double-reserve the required resources even if the bearer config is the same.

In the given scenario, it is assumed that, initially, the source MN configures the UE with CPC from the source SN to the target SN. Then, the source MN initiates the CHO preparation towards the target MN where the target MN prepares the CHO-DC configuration.

According to an example, in order to prevent a delta configuration, thereby avoiding a CHO-CPC coexistence validity problem, a source MN provides existing CPC related information as part of a CHO request to a target MN. That is, a source master node provides existing CPC related information as part of a CHO request to a target master node. The existing CPC related information can be relayed to a target secondary node, such that the target master node and the target secondary node become aware of the ongoing CPC configuration. Accordingly, the target secondary node can configure a full SCG configuration that will be valid before and after CPC execution that was prepared by the source master node. As such, double resource reservation is prohibited.

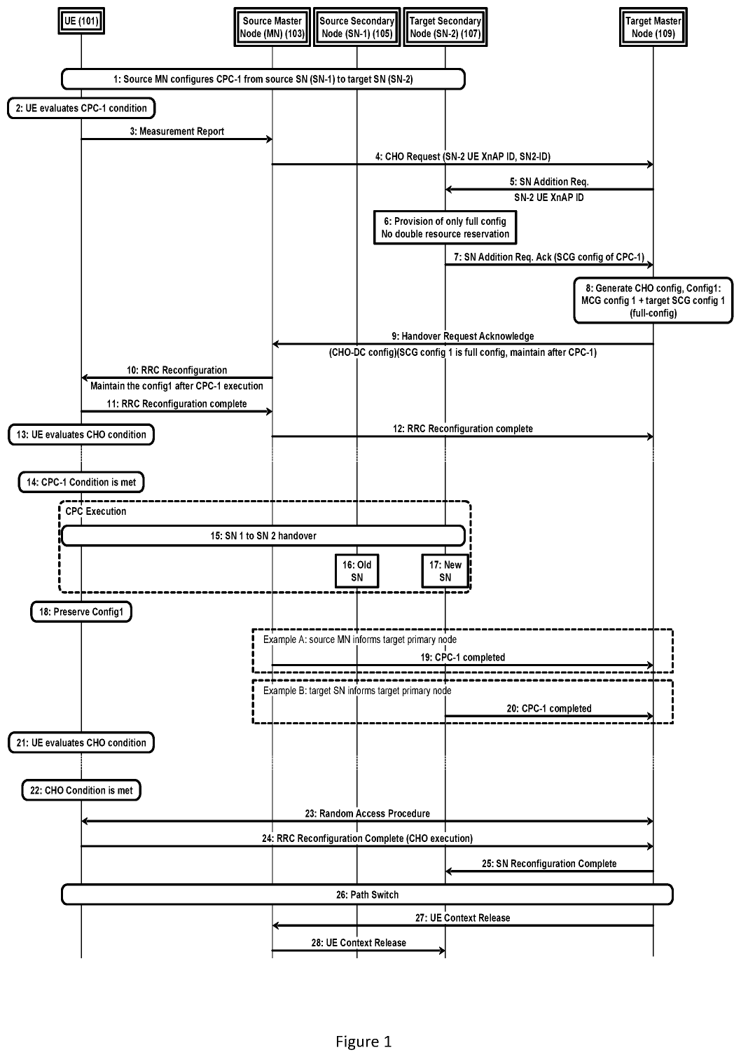

FIG. 1 is a schematic representation of a message flow according to an example, in which, in the context that a source master node prepares a CPC first and then initiates the target master node preparation with CHO-DC, the target master node provides a full SCG configuration as opposed to a delta SCG configuration in order to prevent SCG configuration validity issues in case of a change in the serving secondary node. In an example, the target master node and target secondary node are informed about the ongoing CPC preparation such that the target secondary node will not reserve double resources for the same UE.

Referring to FIG. 1, in blocks 1 and 2, the source master node 103 prepares a CPC, CPC-1, for a UE 101 to change its serving SN from source secondary node, SN-1, 105 to target secondary node, SN-2, 107. UE 101 evaluates the CPC-1 condition in block 2. UE 101 sends a measurement report (3) to its source master node 103 to initiate target master node 109 CHO preparation. The source master node 103 then sends (4) the CHO request to the target master node 109.

According to an example, as part of the CHO request message (4), the source master node also includes the SN UE XnAP ID that is defined between the target secondary node, SN-2, 107 during the CPC-1 preparation of the UE for communication over the Xn interface to the source master node 103. The source master node 103 also sends the ID of SN-2 (107) to the target master node 109 to indicate between which source master node 103 and secondary node the UE 101 XnAP ID was defined. The target secondary node (107) is same secondary node that the source master node configures CPC towards a target secondary node (i.e., it is not any arbitrary secondary node identifier).

The target master node 109 sends (5) a secondary node addition request to the target SN-2 (107) to prepare the target SN-2 with CHO-DC. Target master node 109 includes the target SN-2's UE XnAP ID in that message as the target master node 109 is aware that the target secondary node 107 required this information (SN-2 ID was sent in message (4).

The target secondary node SN-2 (107) becomes aware that the UE 101 which was configured for CPC from source secondary node, SN-1, 105 to target secondary node SN-2, 107 is requested for SN addition by the target master node 109 due to the SN-2 UE XnAP ID that was provided as part of the SN addition request message (5). Accordingly, the target secondary node, SN-2, 107 does not reserve resources twice for the same UE 101, if the bearer configuration allows for optimisation. Furthermore, it provides a full SCG configuration instead of a delta configuration as the delta configuration can become invalid if the CPC is executed by the UE 101, but a full SCG configuration cannot be.

The target secondary node, SN-2, 107 acknowledges (7) its preparation for the requested UE 101 and sends (7) the full SCG configuration that it has generated. The target master node 109 then generates (8) a CHO-DC configuration comprising an MCG configuration for the target master node 109 and a full SCG configuration for the target secondary node 107.

The target master mode 109 transmits (9) a handover request acknowledge message to the source master node 103. It also indicates that the CHO-DC configuration will be valid even if the CPC-1 that is prepared by the source master node 103 is executed by the UE 101. This enables the source master node 103 to avoid cancelling a CHO in case the CPC is executed first.

The UE 101 transmits (11) an RRC Reconfiguration complete message to the source master node 103, and the source master node 103 relays this information (12) to the target master node 109. After receiving CHO-DC, UE 101 starts monitoring the CHO execution condition in block 13. If the CPC-1 condition is met in block 14, UE 101 executes the CPC-1, i.e., it hands over (15) from the source secondary node, SN-1, 105 (old secondary node 16) to the target secondary node, SN-2, 107 (new secondary node 17) without changing its source master node. As it was indicated in message 10, UE 101 preserves the CHO-DC configuration as it will still be valid due to the full SCG configuration.

According to an example, as the target master node 109 needs to be notified about the serving secondary node change, the source master node 103 can inform (19) the target master node 109. In another example, the target secondary node, SN-2, 107 (now the new secondary node 17) can inform (20) the target master node 109.

Since the CHO-DC configuration is valid after CPC-1 execution, UE 101 can continue to monitor the CHO-DC condition (21). If the condition is met (22), UE 101 can execute the CHO towards the target master node 109 and apply the full SCG configuration to connect target secondary node, SN-2, with the new configuration (22-28). During the UE context release (27) the secondary node 107 can be informed to not release the UE context if the CHO has the same target SN. Such an indication can be sent from the target master node 109 to the source master node 103 and from the source master node to the target secondary node 107. In an example, this can be an alternative for 4-5, to avoid UE context being released by the target secondary node. Alternatively, this indication can be sent (28) from the source master node 103 to the target secondary node, SN-2, 107 to avoid UE context being released.

Examples in the present disclosure can be provided as methods, systems or machine-readable instructions, such as any combination of software, hardware, firmware or the like. The machine-readable instructions may, for example, be executed by a machine such as a general-purpose computer, a platform comprising user equipment such as a smart device, e.g., a smart phone, and/or a network entity, such as a base station or node in a radio network for example. Modules of apparatus (for example, a module to generate a CHO configuration, a CHO with DC configuration, a CPC configuration and so on) may be implemented by a processor executing machine readable instructions stored in a memory, or a processor operating in accordance with instructions embedded in logic circuitry. The methods and modules may all be performed by a single processor or divided amongst several processors.

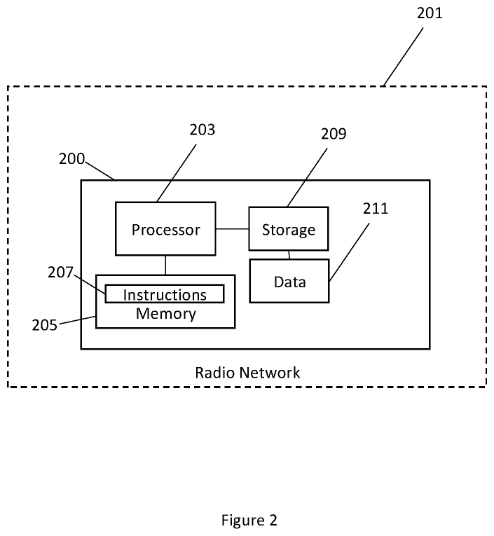

FIG. 2 is a schematic representation of a machine according to an example. The machine 200 can be, e.g., a node in a radio network. For example, the machine 200 can be a source master node 103 or a target master node 109 in a radio network 201. The machine 200 comprises a processor 203, and a memory 205 to store instructions 207, executable by the processor 203. The machine comprises a storage 209 that can be used to store data 211 representing any one or more of a CHO configuration, a CHO with DC configuration, a CPC configuration, an identifier for a UE and/or a node and so on, as described above. In an example, the instructions 207, executable by the processor 203, can cause the machine 200 to receive, from a source master node, a conditional handover, CHO, request message comprising a unique identifier for a UE defined between the source master node and a target secondary node, and an identifier for the target secondary node, and transmit the unique identifier for the UE to the target secondary node as part of an secondary node addition request for CHO with DC preparation.

In an example, the instructions 207, executable by the processor 203, can cause the machine 200 to receive, from the target secondary node, an acknowledgement message to confirm CPC preparation for the UE, the acknowledgement message comprising a full secondary cell group, SCG, configuration.

The machine 200 can implement a method for preparing handover of user equipment, UE, in dual connectivity, DC, where the handover is between respective primary cells, PCells, of a source master node and a target master node, and respective primary secondary cells, PSCells, of a source secondary node and a target secondary node. In an implementation, the machine is a target master node, and the instructions are executable by a processor of the target master node.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

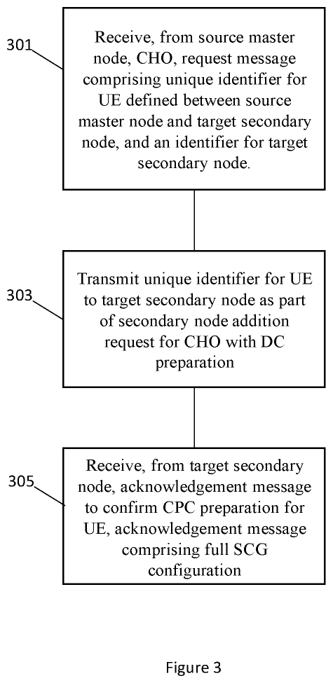

FIG. 3 is a flow chart of a method according to an example. In the example of FIG. 3, the method is suitable for preparing handover of user equipment, UE, in dual connectivity, DC, where the handover is between respective primary cells, PCells, of a source master node and a target master node, and respective primary secondary cells, PSCells, of a source secondary node and a target secondary node. In block 301 a conditional handover, CHO, request message comprising a unique identifier for the UE defined between the source master node and the target secondary node, and an identifier for the target secondary node is received, from the source master node, by the target master node The target secondary node in question is a secondary node that the source master node has already configured a CPC with.

In block 303, the unique identifier for the UE is transmitted to the target secondary node as part of an secondary node addition request for CHO with DC preparation. In block 305, an acknowledgement message to confirm CPC preparation for the UE is received (by the target master node) from the target secondary node, the acknowledgement message comprising a full secondary cell group, SCG, configuration.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1-15. (canceled)

16. A method, performed in a target master node of a radio network, for preparing handover of user equipment, UE, in dual connectivity, DC, where the handover is between respective primary cells, PCells, of a source master node and a target master node, and respective primary secondary cells, PSCells, of a source secondary node and a target secondary node, the method comprising:
receiving, from the source master node, a conditional handover, CHO, request message comprising a unique identifier for the UE defined between the source master node and the target secondary node, and an identifier for the target secondary node;
transmitting the unique identifier for the UE to the target secondary node as part of an secondary node addition request for CHO with DC preparation;
receiving, from the target secondary node, an acknowledgement message to confirm CPC preparation for the UE, the acknowledgement message comprising a full secondary cell group, SCG, configuration.

17. The method as claimed in claim 16, further comprising:
transmitting, to the source master node, a handover request acknowledgement message comprising data representing an indication that the CHO with DC contains a full SCG configuration as well as an indication that the provided configuration will be maintained by the UE after the execution of ongoing CPC configuration of the UE.

18. The method as claimed in claim 16, further comprising:
receiving, from the source master node, a confirmation of UE handover from the source SN to the target SN.

19. The method as claimed in claim 16, further comprising:
receiving, from the target SN, a confirmation of UE handover from the source secondary node to the target secondary node.

20. The method as claimed in claim 16, wherein the full SCG configuration is valid before and after execution of UE handover from the source secondary node to the target secondary node.

21. A source master node in a radio network, the source master node comprising:
a processor;
a memory coupled to the processor, the memory configured to store program code executable by the processor, the program code comprising one or more instructions, whereby to cause the source master node to:
transmit, to a target master node of the radio network, a CHO request message comprising a unique identifier for the UE defined between the source master node and the target secondary node, and an identifier for the target secondary node; and
receive, from the target master node of the radio network, a handover request acknowledgement message comprising data representing an indication that the CHO configuration contains a full SCG configuration as well as an indication that the provided configuration will be maintained by the UE after the execution of ongoing CPC configuration of the UE.

22. The source master node as claimed in claim 21, wherein the program code further comprises one or more instructions, whereby to cause the source master node to:
transmit, to the target master node, a confirmation of UE handover.

23. The source master node as claimed in claim 21, wherein the program code further comprises one or more instructions, whereby to cause the source master node to:
transmit, to the UE, data comprising an indication that the CHO with DC configuration is to be maintained after execution of the CPC.

24. A machine-readable storage medium encoded with instructions for preparing handover of user equipment, UE, in dual connectivity, DC, where the handover is between respective primary cells, PCells, of a source master node and a target master node, and respective primary secondary cells, PSCells, of a source secondary node and a target secondary node, the the instructions executable by a processor of the target master node, whereby to cause the target master node to:
receive, from the source master node, a conditional handover, CHO, request message comprising a unique identifier for the UE defined between the source master node and the target secondary node, and an identifier for the target secondary node;
transmit the unique identifier for the UE to the target secondary node as part of an secondary node addition request for CHO with DC preparation;
receive, from the target secondary node, an acknowledgement message to confirm CPC preparation for the UE, the acknowledgement message comprising a full secondary cell group, SCG, configuration.

25. The machine-readable storage medium as claimed in claim 24, further encoded with instructions executable by the processor of the target master node, whereby to cause the target master node to:
transmit, to the source master node, a handover request acknowledgement message comprising data representing an indication that the CHO with DC contains a full SCG configuration as well as an indication that the provided configuration will be maintained by the UE after the execution of ongoing CPC configuration of the UE.

26. The machine-readable storage medium as claimed in claim 24, further encoded with instructions executable by the processor of the target master node, whereby to cause the target master node to:
receive, from the source master node, a confirmation of UE handover from the source SN to the target SN.

27. The machine-readable storage medium as claimed in claim 24, further encoded with instructions executable by the processor of the target master node, whereby to cause the target master node to:
receive, from the target SN, a confirmation of UE handover from the source secondary node to the target secondary node.

28. A target master node in a radio network, the target master node comprising:
a processor;
a memory coupled to the processor, the memory configured to store program code executable by the processor, the program code comprising one or more instructions, whereby to cause the target master node to:
receive, from a source master node, a conditional handover, CHO, request message comprising a unique identifier for a UE defined between the source master node and a target secondary node, and an identifier for the target secondary node;
transmit the unique identifier for the UE to the target secondary node as part of an secondary node addition request for CHO with DC preparation; and
receive, from the target secondary node, an acknowledgement message to confirm CPC preparation for the UE, the acknowledgement message comprising a full secondary cell group, SCG, configuration.

29. The target master node as claimed in claim 28, wherein the program code further comprises one or more instructions, whereby to cause the target master node to:
transmit, to the source master node, a handover request acknowledgement message comprising data representing an indication that the CHO with DC contains a full SCG configuration as well as an indication that the provided configuration will be maintained by the UE after the execution of ongoing CPC configuration of the UE.

30. The target master node as claimed in claim 28, wherein the program code further comprises one or more instructions, whereby to cause the target master node to:
receive, from the source master node, a confirmation of UE handover from the source SN to the target SN.
